(19) United States
(12) Patent Application Publication
(10) Pub. No.: US 2006/0085629 A1
(43) Pub. Date: Apr. 20, 2006

(54) Mapping a reset vector

(75) Inventors: Robert C. Swanson, Olympia, WA (US); Michael A. Rothman, Puyallup, WA (US); Vincent J. Zimmer, Federal Way, WA (US)

Correspondence Address: INTEL CORPORATION, P.O. BOX 5326, SANTA CLARA, CA, 95056-5326, US

(73) Assignee: Intel Corporation

(21) Appl. No.: 11/292,714

(22) Filed: Dec. 1, 2005

Related U.S. Application Data
(63) Continuation-in-part of application No. 10/746,754, filed on Dec. 24, 2003.

(51) Int. Cl. G06F 15/177

(52) U.S. Cl. 713/1

(57) ABSTRACT

The present disclosure relates to booting a computing device, and more specifically mapping a reset vector to a block device attached via a peripheral device bus.

### RELATED APPLICATIONS

This application is a continuation-in-part (CIP) of U.S. non-provisional application Ser. No. 10/746,754, filed Dec. 24, 2003.

### BACKGROUND

1. Field

The present disclosure relates to booting a computing device, and more specifically mapping a reset vector to a block device attached via a peripheral device bus.

2. Background Information

Block storage (input/output) devices are typically used as mass storage devices. For example, the most common block device is a hard disk drive. Other common block devices include optical storage devices, removable storage media devices (e.g., Iomega's zip drives, USB-based detachable solid state memory), DVD/CD-ROM devices, and floppy drives.

A typical block storage device access interface stack in accordance with conventional practices is shown in FIG. 1. The stack is divided into two major portions: software components 100 and hardware components 102. Software components 100 include an operating system (OS) having a kernel 106 and user space 108. A user application 110 runs in the user space 108, while an OS device driver 112 resides at the kernel level of the OS.

The hardware components 102 include a firmware device driver 114, a device controller 116, and a block storage device 118, such as a hard disk drive 120. The firmware device driver 114 and device controller 116 typically reside on a computer system motherboard 122. More specifically, the firmware device driver typically resides on a boot firmware device (e.g., “Flash chip”) on motherboard 120, while the device controller may comprise a separate component mounted on motherboard 122, or might possibly be included as part of the system's chip set.

The interface stack in FIG. 1 is used to abstract the underlying block storage from users running application in user space 108. For example, suppose user application 110 comprises a file access application such as Microsoft's Explorer, which depicts the file structure stored on mass storage devices like disk drive 120 as a file tree 124. The underlying file data are addressed as blocks on block storage device 118, hence the name “block device.” However, the concept of addressable blocks of storage cannot directly support a workable user interface, such as file tree 124. Thus, components in the OS kernel, including OS device driver 112, are used to abstract the user interface from the underlying storage. These components include a FAT (file allocation table) 126, which maps files and folders to corresponding storage blocks via a block address map 128. A partition table 130 is also included. In addition to dividing the block address of block storage device 118 into necessary partition, partition table 130 may also be used to create logical partitions, such that the same physical block storage device may appear to applications running in operating system 104 as separate “virual” storage devices.

Generally, the components at the OS kernel 106 layer control access to a system's block storage devices, using software abstractions. However, under most implementations, anyone running the computer system has access to data stored on a system's own block storage devices, while remote block storage devices hosted by other remote systems may be access if sharing is enabled for such devices (via the OS's on the remote systems), and if the user has proper credentials to use the share(s).

In addition to block address mapping, the OS kernel is responsible for file/directory access. That is, a component such as FAT 16 maintains file access attribute data that define the types of accesses that are allowed. For example, a file may have a “read-only” attribute that prevents the file from being modified. Other files may be “hidden,” or otherwise only accessible to someone with the proper authority, such as a system administrator. Thus, the operating system is the gatekeeper for accessing block storage devices under conventional practices.

### BRIEF DESCRIPTION OF THE DRAWINGS

Subject matter is particularly pointed out and distinctly claimed in the concluding portions of the specification. The claimed subject matter, however, both as to organization and the method of operation, together with objects, features and advantages thereof, may be best understood by a reference to the following detailed description when read with the accompanying drawings in which:

FIG. 1 is a schematic diagram illustrating a block device access interface stack;

FIG. 2 is a schematic diagram illustrating an embodiment of a platform architecture to facilitate mapping a reset vector in accordance with the disclosed subject matter;

FIG. 3 is a table illustrating various attributes and data corresponding to a block exclusion vector (BEV) entry, in accordance with the disclosed subject matter;

FIG. 4 is a schematic diagram illustrating an exemplary implementation of a BEV-based access qualification mechanism that is implemented in an Intel® controller hub ASIC, according to one embodiment of the disclosed subject matter;

FIG. 5 is a flowchart illustrating an embodiment to facilitate mapping a reset vector in accordance with the disclosed subject matter; and

FIG. 6 is a flowchart illustrating an embodiment to facilitate mapping a reset vector in accordance with the disclosed subject matter; and

FIG. 7 is a flowchart illustrating an embodiment to facilitate mapping a reset vector in accordance with the disclosed subject matter; and

FIG. 8 is a schematic diagram illustrating an embodiment of a platform architecture to facilitate mapping a reset vector to a removable block device in accordance with the disclosed subject matter.

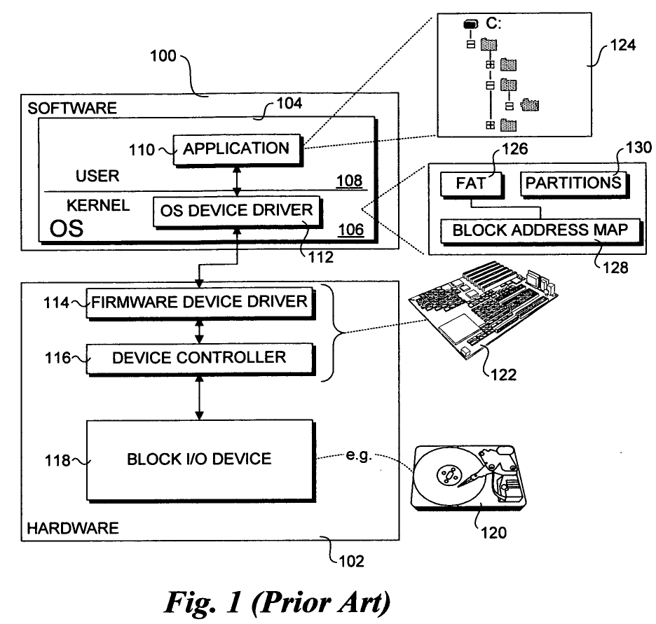

### DETAILED DESCRIPTION

In the following detailed description, numerous details are set forth in order to provide a thorough understanding of the present claimed subject matter. However, it will be understood by those skilled in the art that the claimed subject matter may be practiced without these specific details. In other instances, well-known methods, procedures, components, and circuits have not been described in detail so as to not obscure the claimed subject matter.

This specification describes a system and method wherein software and hardware may be combined to map a central processing unit (CPU) reset vector to a block mode mass storage device (a.k.a. “block device”). In one embodiment, the reset vector may be remapped from a flash BIOS that resides on a slow speed bus (as is currently done) to a block device that resides on a higher speed bus, such as, for example, and flash drive on a Universal Serial Bus (USB).

This specification also describes and utilizes a system and method wherein software and hardware may qualify the mode of access to a block mode mass storage device. This method entails designating an arbitrary number of separate regions of the block device with attributes that control access to the data stored in those regions. The attributes include “Read-Only,” “Read-Write,” “Write-Only,” “Write-Once,” accessible only to code with an established key token (“Key Accessible”), and “Inaccessible.” These settings can be established by pre-boot or runtime firmware or an operating system and locked to a given state. In one embodiment, setting the attributes and locked state is a one-time operation and the state remains locked until the machine is rebooted. All attributes are cleared at system reboot.

In one embodiment, the block device access control mechanism is implemented via the block device's controller hardware by employing the concept of a Block Exclusion Vector (BEV) added to the state information managed by controller, such as that found in the Intel® Controller Hub (ICH) chipset ATA disk controller component. The mechanism can be implemented in any block mode storage device controller, so it can apply equally to integrated controllers such as those in Intel® chipsets or in third party controllers implemented as stand-alone controller chips or add-in cards. The mechanism does not rely on any features being implemented in the attached block devices, thus it can manage access to any existing device that is compatible with the data access interface of the particular controller (ATA, EIDE, SCSI, Fiber channel, etc.).

In one embodiment, the BEV provides fine-grained settings with optional authorization fields. One could think of this vector as being analogous to a primitive Access Control List (ACL) for raw I/O access to a block device managed by a controller that implements support for BEV. A region designated Write-Once, for example, would be ideal for the creation of an audit log that could not be altered after data is written to the log. The Read-Only attribute would be useful for storing firmware images on disk such that they could be executed without fear of tampering (i.e., integrity maintenance).

In one embodiment, there may be temporal aspect to the settings of a given BEV entry in that these may be established some time after the system boots. This means that the ability to access areas of the storage device may vary over time. For example, the platform firmware may wish to protect a region of mass storage from write access by code that runs subsequent to it while maintaining the ability to read and write the region as the firmware itself operates. This can be accomplished by waiting to set the BEV for the region to Read-Only until the firmware has completed its work whereupon all subsequent accesses to that region of the device are limited to read operations only.

The BEV mechanism provides the ability to qualify access to certain regions of the disk, such as an Extensible Firmware Interface (EFI) system partition, so that errant software or malware cannot accidentally or maliciously change the state of information that is vital to correct system operation. It should be noted however, that this art is equally applicable to any block mode device controllers, so, for example, the access mechanism could be used to control access to regions of flash storage implemented and accessed as a block device. Thus, the mechanism may be implemented for accessing solid-state storage devices, such as the flash devices use today for digital cameras and PDAs (personal digital assistant) that employ a standard flash form factor (e.g. compact flash) and are accessed as ATA devices.

One of the more powerful applications of this art in cost sensitive platforms would be to supplant the requirement for relatively expensive flash storage wired to the platform motherboard as a store for the boot code that runs when the CPU comes out of reset. Given a region of mass storage protected with a BEV entry, the data stored in this region can have the same level of integrity and protection from editing, removal or replacement as data stored in a flash device. In combination with the BEV, a mass storage controller may be implemented to map the CPU reset vector to an area of an attached mass storage device protected by such a BEV entry. Doing so may accomplish the same functionality as flash storage memory mapped at the reset vector and providing much larger storage capacities but at a fraction of the cost of current firmware hub flash technology devices.

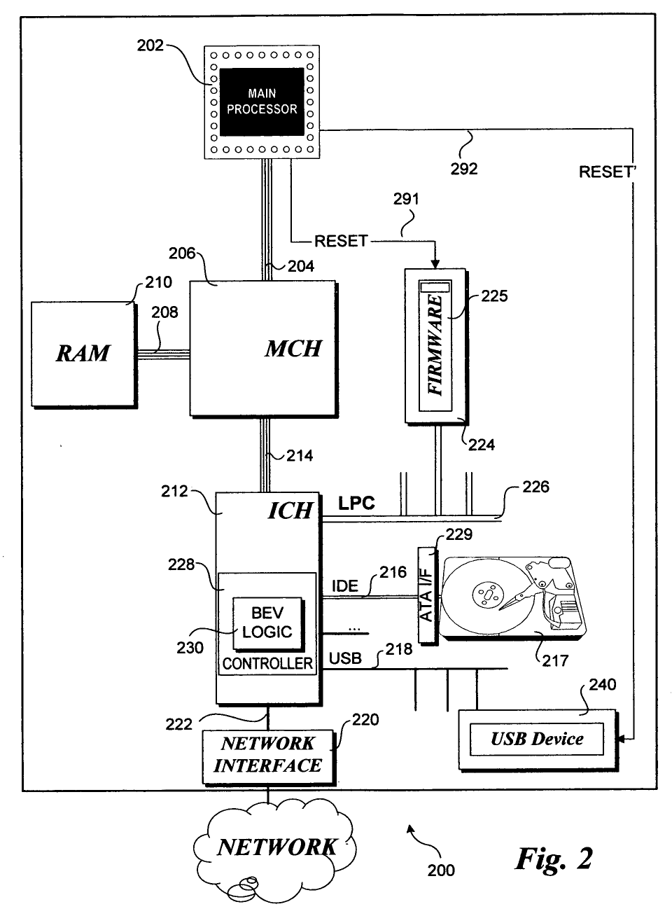

An exemplary platform architecture 200 that may be employed for implementing embodiments of the disclosed subject matter is shown in FIG. 2. Platform architecture 200 includes a main processor 202 coupled, via a bus 204, to a memory controller hub (MCH) 206, commonly referred to as the “Northbridge” under well-known Intel® chipset schemes. MCH 206 is coupled via a bus 208 to system memory (e.g. RAM) 210. MCH 206 is further coupled to an Input/Output (I/O) controller hub (ICH) 212 via a bus 214. The ICH, which is commonly referred to as the “Southbridge,” provides a hardware interface to various I/O buses, ports and devices. These include an IDE interface 216 to which an IDE hard disk 217 is coupled, a universal serial bus (USB) 218 to which an USB Device 240 is coupled, etc. In one embodiment, the USB Device 240 may be a device, such as, for example, a flash pen drive. ICH 212 is further coupled to a network interface 220 via an I/O path 222. In addition, a firmware storage device 224 is communicatively coupled to ICH 212 via a low pin count (LPC) bus 226. In one embodiment, the LPC bus 226 is configured per Intel LPC Interface Specification Revision 1.0, Sep. 29, 1997. In the illustrated embodiment, firmware storage device 224 comprises a boot firmware device (BFD) contain bootable system firmware 225.

Under the architecture illustrated in FIG. 2, ICH 212 comprises an ASIC (application specific integrated circuit) containing embedded logic that is “programmed” in the ASIC using appropriate gate configurations, as is well-known in the art. A portion of ICH 212's embedded logic is dedicated to provide logic and control operations corresponding to a controller 228. In the illustrated embodiment, controller 228 comprises an IDE controller, while disk drive 217 employs an IDE or EIDE interface. Furthermore, controller 228 contains logic to effect interface operations with disk drive 217 in accordance with the ATA command set that is processed by an ATA interface 229. It is noted that this is merely illustrative of one implementation of the disclosed subject matter, as controller 228 may be programmed to effect other types of block device controllers, including but not limited to SCSI (small computer system interface) devices, Firewire (IEEE 1394) devices, and USB devices.

In accordance with one embodiment of the disclosed subject matter, the block device access mechanism may be implemented via BEV logic 230 programmed in controller 228. In effect, the BEV logic qualifies access requests based on the logic states of a corresponding BEV state machine. The logic states may be defined by corresponding BEV entries.

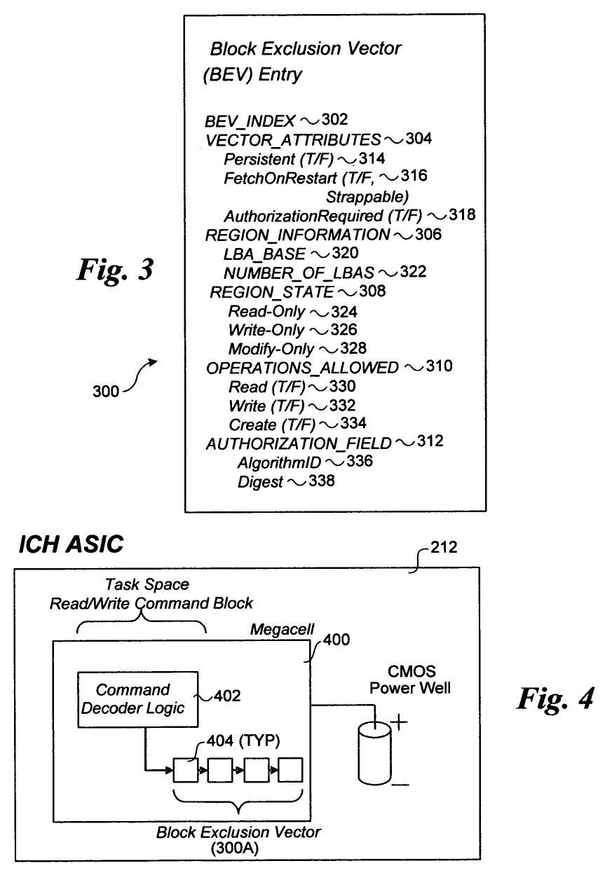

A BEV entry 300 according to one embodiment is shown in FIG. 3. The BEV entry 300 includes a BEV_INDEX 302, VECTOR_ATTRIBUTES 304, REGION_INFORMATION 306, REGION_STATE information 308, OPERATIONS_ALLOWED 310, and an optional AUTHORIZED_FIELD 312. BEV_INDEX 302 is used to maintain an index to the BEV entry.

The VECTOR_ATTRIBUTES 304 may define attributes for the block exclusion vector, and include a Persistent attribute 314, a FetchOnReset attribute 316, and an AuthorizationRequired attribute 318. The Persistent attribute 314 may comprise a Boolean bit indicating whether the entry is to persist (TRUE) or not (FALSE) across a restart (i.e., persist if the computer system is restarted). The FetchOnReset attribute 316 is used for implementations in which firmware may be stored on a block device, such as a disk drive 217, as described below. This attribute may contain two values, a Boolean bit indicating TRUE or FALSE, and a bit indicating whether the block device is strappable. This refers to the ability to bootstrap the system via bootable firmware that is stored on a block storage device rather than a conventional BIOS chip, as described below in detail. The AuthorizationRequired attribute may comprise a Boolean bit indicating whether or not Authorization is required to access the portion of the block device indicated by the block storage request.

The REGION_INFORMATION 306 may contain information corresponding to regions of the block storage device that are controlled via the access mechanism. This includes an LBA_BASE 320 that defines the base address for the logical block addresses (LBAs) provided by the device. A NUMBER_OF_LBAS 322 value specifies the number of logical block addresses available.

The REGION_STATE information 308 identifies corresponding region access states. These include Read-Only 324, Write-Only 326, and Modify-Only 328. The region states define whether or not a corresponding BEV entry may be read, written, or modified. The OPERATIONS_ALLOWED 310 entries include three Boolean bits correspond to respective access operations, including a Read operation 330, a Write operation 332, and a Create operation 334.

The optional AUTHORIZATION_FIELD 312 is used for implementations in which device access is enforced using an authorization scheme. In other words, an authorization scheme is employed to determine whether or not an access requestor is to be provided access to the block device. If the requestor passes an authorization challenge, the request is approved. If not, the request is denied. Exemplary entries for AUTHORIZATION_FIELD 312 include an AlgorithmID 336 and a Digest 338. The AlgorithmID 336 contains an identifier for a corresponding authentication algorithm. In general, the algorithm itself may be stored in firmware 224 or in an operating system. Digest 338 contains a digest that is generated via a hash on an authentication credential or the like, such as a private key.

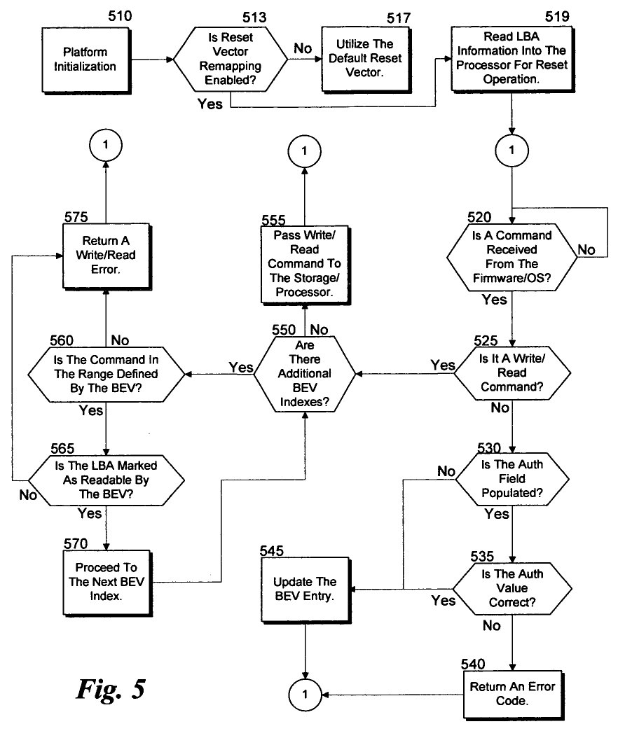

An exemplary scheme for implementing BEV logic 230 is shown in FIG. 4. FIG. 4 shows block levels of an ASIC according to one embodiment of ICH 212. Details of other logic blocks of ICH 212 are removed for clarity. As is common to typical ASICS, device logic is obtained through programming appropriate gates in one or more megacells, such as depicted by a megacell 400. Groups of gates, in turn, are conventionally depicted as logic blocks, wherein each block contains logic for performing a corresponding function. For point of illustration, the megacell 400 contains gate logic for processing Read/Write commands. The logic blocks include Command Decoder Logic 402 and logic blocks 404, which are illustrative of a block exclusion vector entry 300A. In the illustrated embodiment, the ASIC is implemented using a CMOS process that enables the BEV logic to be not only reprogrammable, but also persistent across restarts. However, other processes for implementing ASIC designs in integrated circuits may also be employed.

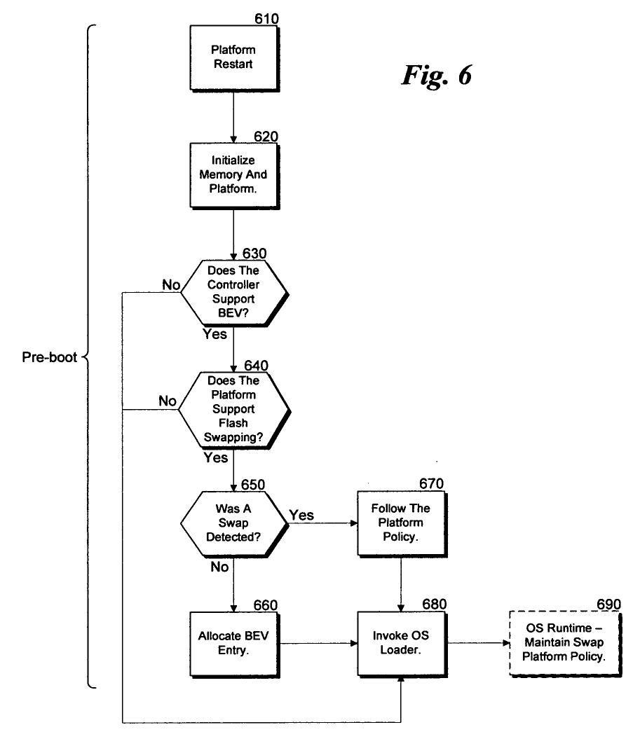

FIG. 6 is a flowchart illustrating an embodiment to facilitate mapping a reset vector in accordance with the disclosed subject matter. Block 610 illustrates that in one embodiment, the platform may be restarted. In one embodiment, the platform may include the platform 200 illustrated by FIG. 2. Block 620 illustrates that, in one embodiment, normal memory and platform initialization may occur.

Block 630 illustrates that, in one embodiment, a determination may be made whether or not the ICH (or equivalent) supports BEV. In some embodiments, a system similar to BEV may be employed. If the system does not support BEV, Block 680 illustrates that, in one embodiment, the OS loader may be invoked.

Block 640 illustrates that, in one embodiment, if the system supports BEV a determination may be made whether or not the system supports flash swapping. If the system does not support flash swapping, Block 680 illustrates that, in one embodiment, the OS loader may be invoked. This is illustrated in FIG. 2 by Reset Vector 291 that invokes the OS loader stored on firmware 225. In one embodiment, the firmware may be hardwired as the default OS loader.

Block 650 illustrates that, in one embodiment, if the system supports flash swapping a determination may be made whether or not a swap has been detected. In one embodiment, a USB device containing a flash block device may be used to boot the system. This may be illustrated by FIG. 2 where USB device 240 includes an OS loader and firmware.

Block 670 illustrates that, in one embodiment, if a swap was detected the platform policy may be followed. In one embodiment, the platform policy may limit the appropriate devices that may be used to boot the system. In one embodiment, the devices may be limited based upon criteria, such as, for example, the type of block device, the bus utilized by the block device, an authentication scheme, or a Read/Write setting. A flowchart that illustrates one embodiment of a platform policy is shown in FIG. 5 and described in more detail below. It is understood that more complex platform policies may exist and that FIG. 5 is merely one illustrative embodiment.

Once the platform policy is followed, Block 680 illustrates that the selected OS loader may be invoked to boot the system. In one embodiment, FIG. 2 illustrates that the selected OS loader may reside on USB device 240. The reset vector of the CPU 202 may be remapped from the default vector 291 which points to firmware 225 to vector 292 which points to USB device 240.

Block 660 illustrates that, in one embodiment, if a swap was not detected the various BEV entries may be allocated. In one embodiment, the BEV may create an entry for each block device included within the system. The default OS loader may be invoked, as illustrated by Block 680. If no swap occurred the default OS loader may be loaded, as illustrated in FIG. 2 by vector 291.

Block 690 illustrates that once the OS is loaded, either via the default OS loader or the swapped OS loader, the OS may enter runtime mode. In one embodiment, the platform's swap policy may be maintained during the OS runtime. For example, some systems may dictate that a log be written to the firmware. Traditionally, this firmware was hardwired into the system, as illustrated by firmware 225 of FIG. 2. In one embodiment, the system may allow the firmware to be swapped during the runtime of the system. Therefore, the log may be written to an easily transferable flash pen drive, such as, for example, USB device 240 of FIG. 2. In one embodiment, the platform's policy may only allow a firmware swap only if the firmware, or a portion of the firmware, is marked as Write-Only or Write-Once.

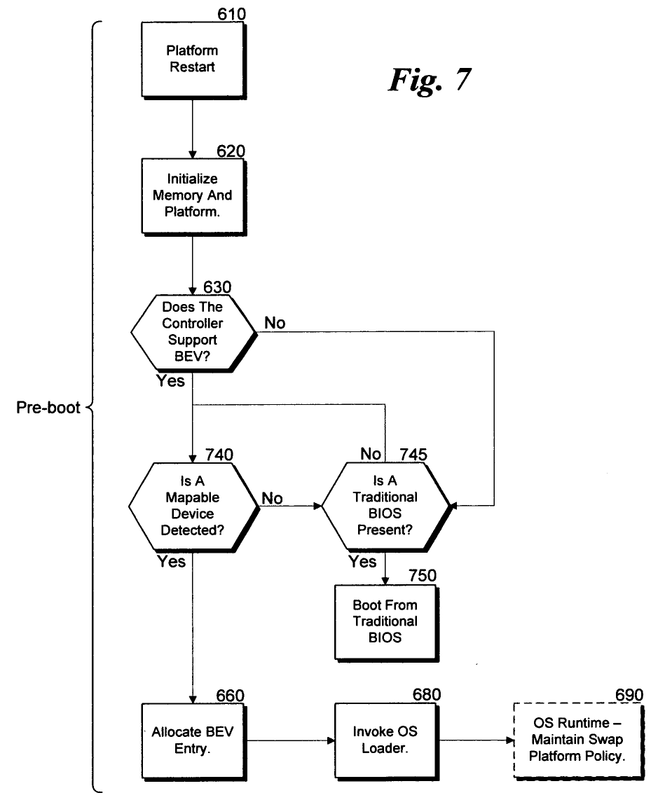

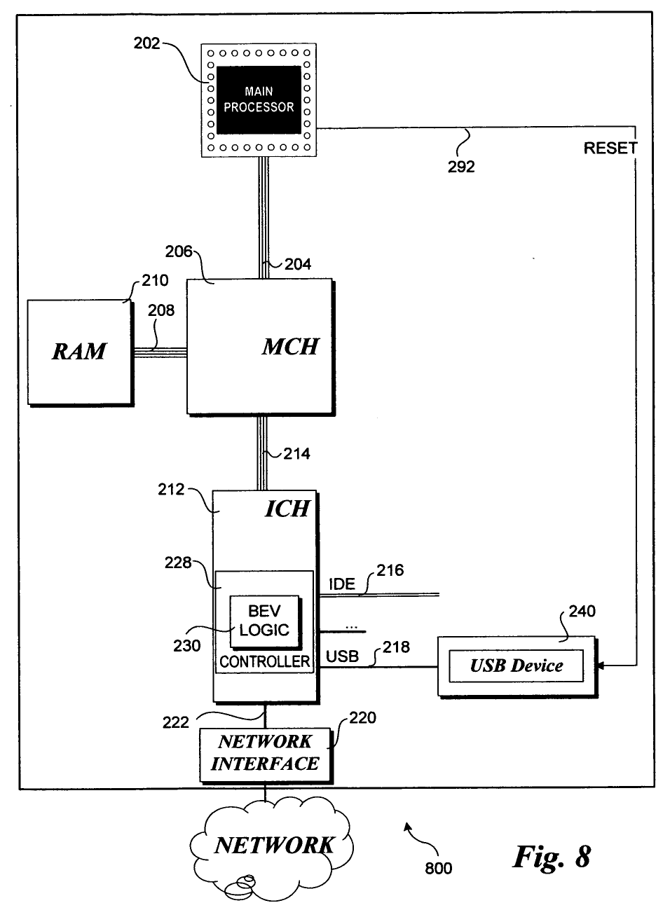

FIG. 7 is a flowchart illustrating an embodiment to facilitate mapping a reset vector in accordance with the disclosed subject matter. FIG. 7 differs from FIG. 6 in that it illustrates an embodiment of the disclosed subject matter in which the reset vector is initially mapped to a removable block device, as opposed to remapped from a traditional flash device. This is illustrated in FIG. 8 which is a schematic diagram illustrating an embodiment of a platform architecture to facilitate mapping a reset vector to a removable block device.

The embodiment illustrated in FIG. 8, the LPC bus 226 and the firmware 224 (which includes the boot loader 225) of FIG. 2 are removed. This is notable in that traditional computer system require these fundamental components in order to operate. Instead, the system 800 of FIG. 8, relies upon the removable flash 240 to provide the boot loader functionality. In this embodiment, the removable flash is illustrated as a USB device 240; however, it is understood that other removable block devices may be used.

In the embodiment, illustrated by FIG. 8 the IDE interface 216 to which an IDE hard disk 217 of FIG. 2 may also be removed. In one embodiment, the system 800 may allow for the USB Device 240 (or equivalent) to provide an entire “system-on-a-disk”. In one embodiment, the USB device may provide a boot loader, operating system, and applications. In another embodiment, the operating system and other programs may be provided via other techniques, such as, for example, downloaded from a network.

In FIG. 7 blocks 610, 620, and 630 may proceed as described above in relation to FIG. 6. Block 740 illustrates that a determination may be made whether or not a mapable device exists within the system. In one embodiment, the system may select between a number of mapable devices. For example, the system may have a hierarchy of mapable devices that it will use to boot the system.

If a bootable device exists, Blocks 660, 680, and 690 illustrate that the system may be booted via that device. These blocks are described in more detail above in relation to FIG. 6. For example, if the USB Device 240 from FIGS. 2 & 8 is available, the system may proceed to use reset vector 292 to map the device and boot the system.

In one embodiment, if there are no mapable devices detected, Block 745 illustrates that an attempt may be made to find a traditional BIOS or boot loader. If such a boot loader is discovered, Block 750 illustrates that this may be used to boot the system. For example, some embodiments may include a back-up boot loader as illustrated by firmware 225 of FIG. 2. While the system 200 of FIG. 2 may use firmware 225 as the primary boot loader, other embodiments may utilize the firmware as a fall back position. In one other embodiment, the back-up or fall-back boot loader may be provided on a hard drive or other fixed media, such as for example the IDE drive 217 of FIG. 2. In other embodiments, as illustrated by FIG. 8, no back-up or fall-back boot loader may be provided.

FIG. 5 is a flowchart illustrating an embodiment to facilitate mapping a reset vector in accordance with the disclosed subject matter. In one embodiment the logic illustrated by FIG. 5 may be embodied within controller in either firmware, hardware or a combination thereof. In one embodiment, the controller may be the controller illustrated by controller 228 of FIG. 2.

Block 510 illustrates that the platform may be initialized. Block 513 illustrates that, in one embodiment, a determination may be made whether or not reset vector remapping is supported by the system. If reset mapping is not supported, Block 517 illustrates that, in one embodiment, the default reset vector may be utilized. In the embodiment illustrated by FIG. 2, Block 517 may denote that vector 291 may be used to initialize the boot loader found within firmware 225.

Block 519 illustrates that, in one embodiment, the LBA (logical block address) of the block device corresponding to the remapped reset vector may be read into the processor. In one embodiment, illustrated by FIG. 2, once the reset vector remapping is detected by Block 513 of FIG. 5, the reset vector may be remapped from vector 291 to vector 292.

Block 520 illustrates that, in one embodiment, a determination may be made whether or not the information received from the firmware, OS, or other controlling software, firmware, hardware, or combination thereof is a command. If not, the machine may enter a wait state.

Block 525 illustrates that, in one embodiment, that if the received information is a command, a determination may be made whether or not the command is a read/write command.

If the FetchOnRestart attribute is not set, a determination is made in a decision block 532 to whether the AUTHORIZATION_FIELD 312 is populated.

If the answer to decision block 532 is NO, the logic proceeds to a block 534 in which the BEV entry is updated. If authorization field attributes exist, a determination is made in a decision block 536 to whether the authentication value is correct. If the answer to Block 530 is NO, the logic proceeds to a Block 545 in which the BEV entry is updated.

If the command is not a read/write command, Block 530 illustrates that the Authorization Field of the BEV entry may be examined. The determination in this decision block relates to whether a user must be authenticated to access or modify the BEV entries. Such authentication may be applicable for individual BEV entries, or all entries as a whole. In the case of individual BEV entries, respective authentication field data are provided for each BEV entry. The optional authentication fields support an implementation policy under which BEV entries cannot be inadvertently or maliciously changed by unauthorized parties. Furthermore, this authentication scheme supports the possibility of extending the basic mechanism in a way that permits attributes to be set more than once during a session, without requiring a platform reset. If the answer to Block 530 is NO, the logic proceeds to a Block 545 in which the BEV entry is updated.

If the Authorization field is populated, Block 535 illustrates that, in one embodiment, a determination may be made whether or not the value in the authorization field is correct. For instance, authentication credentials may be compared using an authentication algorithm identified by AlgorithmID 336 of FIG. 3. In one embodiment, a platform public key is registered, and the BEV editor is challenged with an encrypted blob (e.g., Digest 338) that the BEV editor must decrypt with its private key. If the decrypted blob matches the private key, authentication is successful. If the authentication value does not match or is otherwise unsuccessful, an appropriate error code is returned in a return block 538. In general, the authorization algorithm and values may also evolve over time. In addition, other types of authentication schemes that are well-known in the art may be employed, including, but not limited to, authentication certificates, asymmetric key pair authentication, symmetric key pair authentication, shared secrets, and passwords/passcodes.

In one embodiment, if the authorization fails, Block 540 illustrates that an error code may be returned.

If the command received in Block 520 is a read/write command, Block 550 illustrates that, in one embodiment, a determination may be made whether or not the end of the block device or at least the portion of the block device controlled by the BEV has been reached. If so, Block 555 illustrates that, in one embodiment, the command may be passed to the storage device or processor (depending upon whether the command was to write or read).

Block 560 illustrates that, in one embodiment, a determination may be made whether or not the command is within the range covered by the BEV. In short, this determination indicates whether or not the data being requested to be accessed falls within an address space that is under the control of a BEV entry. In one embodiment, this determination may be made by iterating through the BEVs via their respective indexes, and checking to see if there is an LBA range overlap between the address range of the requested block(s) and the address range defined by a given BEV entry.

Block 565 illustrates that, in one embodiment, a determination may be made whether or not the command is within a section of the block device marked as readable. Conversely, in one embodiment, a block may exist that determines is a write is allowed to a particular LBA. For example, if the swapped firmware is used to

If these two conditions are not met, Block 575 illustrates that, in one embodiment, an error may be returned. Conversely, Block 570 illustrates that, in one embodiment, if the command is both within the accepted range and readable, the machine may proceed to the next BEV index.

The techniques described herein are not limited to any particular hardware or software configuration; they may find applicability in any computing or processing environment. The techniques may be implemented in hardware, software, firmware or a combination thereof. The techniques may be implemented in programs executing on programmable machines such as mobile or stationary computers, personal digital assistants, and similar devices that each include a processor, a storage medium readable or accessible by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a storage medium or device, e.g. compact disk read only memory (CD-ROM), digital versatile disk (DVD), hard disk, firmware, non-volatile memory, magnetic disk or similar medium or device, that is readable by a general or special purpose programmable machine for configuring and operating the machine when the storage medium or device is read by the computer to perform the procedures described herein. The system may also be considered to be implemented as a machine-readable or accessible storage medium, configured with a program, where the storage medium so configured causes a machine to operate in a specific manner. Other embodiments are within the scope of the following claims.

While certain features of the claimed subject matter have been illustrated and described herein, many modifications, substitutions, changes, and equivalents will now occur to those skilled in the art. It is, therefore, to be understood that the appended claims are intended to cover all such modifications and changes that fall within the true spirit of the claimed subject matter.

The following is claimed:

1: A method of initializing a system comprising:
determining if a bock device controller supports a Block Exclusion Vector (BEV) mechanism;
if so, determining if a block device that includes a boot loader is accessible by the system; and
if so, utilizing the boot loader to initialize the system.

2: The method of claim 1, wherein utilizing the boot loader to initialize the system includes:
allocating a Block Exclusion Vector (BEV) to the block device that includes a boot loader; and
loading at least a portion of the boot loader according to the BEV policy.

3: The method of claim 1, wherein determining if a block device that includes a boot loader is accessible by the system includes:
determining if the system supports the remapping of a reset vector; and if so,
detecting if a first boot loader has been swapped with a second boot loader, and
utilizing a system boot loader policy to remap the reset vector.

4: The method of claim 3, wherein the system boot loader policy includes, when given both a slow boot loader that is coupled with a low pin count (LPC) bus and a fast boot loader that is coupled with a bus that provides a higher bit rate than the LPC bus (i.e. a high speed bus) preferring to utilize the fast boot loader.

5: The method of claim 4, wherein the high speed bus is a Universal Serial Bus (USB).

6: The method of claim 3, wherein
the first boot loader is included within a fixedly-mounted firmware; and
the second boot loader is included within a removable block device.

7: The method of claim 1, wherein determining if a block device that includes a boot loader is accessible by the system includes:
detecting a removable block device that includes a boot loader.

8: The method of claim 7, further including if the removable block device is not detected, utilizing a back-up boot loader.

9: The method of claim 2, further including:
determining if the Block Exclusion Vector (BEV) allows writing information to the block device; and
if so, allowing data to be written to the block device after an operating system has loaded on the system.

10: A system comprising:
a processor;
a removable block device including a boot loader; and
a controller;
wherein the controller is operatively coupled with the processor and the removable block device to facilitate an access qualification mechanism that is capable of facilitating access to specified blocks of the removable block device.

11: The system of claim 10, wherein the system is capable of performing operations in response to a system initialization, including:
determining if the access qualification mechanism allows utilizing the boot loader of the removable block device to facilitate initialization of the system.

12: The system of claim 10, wherein the system does not include a fixedly mounted bootable firmware image.

13: The system of claim 11, wherein the access qualification mechanism utilizes Block Exclusion Vectors (BEVs).

14: The system of claim 13, wherein the system is further capable of:
detecting whether or not the removable block device is communicatively coupled with the processor;
if so, determining if the access qualification mechanism allows utilizing the boot loader of the removable block device to facilitate initialization of the system;
if so, utilizing the boot loader to facilitate initialization of the system.

15: The system of claim 14, wherein the system is further capable of:
if the removable device is either not communicatively coupled with the processor or the access qualification mechanism does not allow utilizing the boot loader of the removable block device to facilitate initialization of the system, attempting to find another block device which is both communicatively coupled with the processor and the access qualification mechanism allows utilizing a boot loader of the another block device to facilitate initialization of the system; and
utilizing the boot loader of the another block device to facilitate initialization of the system.

16: The system of claim 15, including a fixedly mounted block device including a boot loader, wherein the fixedly mounted block device is the another block device of claim 15.

17: The system of claim 16, wherein the fixedly mounted block device is not coupled with the processor via a Low Pin Count (LPC) bus.

18: The system of claim 14, wherein the system is further capable of:
determining if the Block Exclusion Vector (BEV) allows writing information to the removable block device; and
if so, allowing data to be written to the removable block device after an operating system has loaded on the system.

19: An apparatus comprising:
a controller capable of controlling access to a plurality of block devices, wherein at least one block device includes a boot loader (i.e. a boot loadable block device); and
a Block Exclusion Vector (BEV) logic capable of qualifying access to specified blocks on a block storage device;
wherein the controller utilizes, at least in part, the BEV logic to control access to the plurality of block devices.

20: The apparatus of claim 19, wherein the controller is capable of remapping a reset vector from a first boot loadable block device to a second boot loadable block device.

21: The apparatus of claim 20, wherein remapping a reset vector includes:
determining if a system policy allows for boot loader swapping;
detecting if a boot loader swap from the first boot loadable block device to the second boot loadable block device occurred; and
utilizing the second boot loadable block device to boot a system.

22: The apparatus of claim 21, wherein remapping a reset vector further includes:
allocating a Block Exclusion Vector (BEV) for the second boot loadable block device.

23: The apparatus of claim 22, wherein the controller is further capable of:
determining if the Block Exclusion Vector (BEV) for the second boot loadable block device allows write access to at least a portion of the second boot loadable block device; and
if so, allowing writes to occur to the second boot loadable block device after an operating system has loaded.

24: The apparatus of claim 19, wherein the boot loadable block device is not coupled with the controller via a Low Pin Count (LPC) bus.

25: The apparatus of claim 24, wherein the boot loadable block device is a removable block device.

26: The apparatus of claim 19, wherein the controller is capable of:
determining whether or not the boot loadable block device is a removable block device; and
if so, utilizing the removable boot loadable block device to boot a system.

27: The apparatus of claim 26, wherein the controller is further capable of:
if the boot loadable block device is not a removable block device;
determining if a back-up boot loadable block device is available; and
if so, utilizing the back-up boot loadable block device to boot a system.

28: The apparatus of claim 26, wherein the removable boot loadable block device does not utilize a Low Pin Count (LPC) bus.

29: An article comprising:
a machine accessible medium having a plurality of machine accessible instructions, wherein when the instructions are executed, the instructions provide for:
determining if a bock device controller supports a Block Exclusion Vector (BEV) mechanism;
if so, determining if a block device that includes a boot loader is accessible by the machine; and
if so, utilizing the boot loader to initialize the machine.

30: The article of claim 29, wherein the instructions providing for determining if a block device that includes a boot loader is accessible by the system includes instructions providing for:
determining if the system supports the remapping of a reset vector; and if so,
detecting if a first boot loader has been swapped with a second boot loader, and
utilizing a system boot loader policy to remap the reset vector.

31: The article of claim 29, wherein the instructions providing for determining if a block device that includes a boot loader is accessible by the system includes instructions providing for:
detecting a removable block device that includes a boot loader.
